(19) United States
(12) Patent Application Publication
(10) Pub. No.: US 2016/0075409 A1
(43) Pub. Date: Mar. 17, 2016

(54) SYSTEMS AND METHODS OF MOORING AN ARRAY OF WAVE ENERGY CONVERTERS

(71) Applicant: EPITOME PHARMACEUTICALS LIMITED, San Diego, CA (US)

(72) Inventor: Paul Wegener, San Diego, CA (US)

(21) Appl. No.: 14/785,622

(22) PCT Filed: Apr. 18, 2014
(86) PCT No.: PCT/US2014/034726

§ 371 Date: Oct. 19, 2015

Related U.S. Application Data
(60) Provisional application No. 61/814,108, filed on Apr. 19, 2013.

(51) Int. Cl. B63B 21/00; F03B 13/14

(52) U.S. Cl. CPC B63B 21/00; F03B 13/14

(57) ABSTRACT

Contemplated mooring systems have one or more primary tethers that extend laterally and to which respective pluralities of independent secondary tethers are coupled that in turn are coupled to floating marine devices, and especially wave energy converters. The primary tethers are coupled to preferably static seabed anchors and will so provide a simple and dynamic mooring system that provides multiple operational advantages while allowing for simple deployment and maintenance.

This application claims priority to U.S. provisional application having Ser. No. 61/814108, which was filed 19 Apr. 2013.

### FIELD OF THE INVENTION

The field of the invention is ocean mooring systems and methods therefor, especially as they relate to mooring systems for floating wave energy converters that convert the energy of wave motion into mechanical and/or electrical energy.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Energy extraction form moving bodies of water is well known, and typical examples for energy converters are implemented as submerged turbine systems that generate electrical energy from ocean or freshwater currents using a propeller-type structure as described, for example, in GB2497961 or U.S. Pat. No. 8,664,790. Alternatively, a louvered turbine can be used to produce electric energy as discussed in U.S. Pat. No. 8,664,784. As will be readily appreciated, such energy converters will require an anchor or tether structure to prevent loss or damage to the converter. Depending on the type of converter, anchoring can be done using known subsea foundations or suction piles. On the other hand, where the energy converter is installed in relatively shallow bodies of water (e.g., less than 100 m depth), where the vertical position relative to the sea bed must be adjustable, or where tidal flow reverses the flow direction of the water relative to the turbine, installation of the submerged energy converters may also be implemented via a tether structure as shown for example, in GB 2256011, WO 88/04362, WO 2012/123704, U.S. 2010/0230971, U.S. Pat. No. 6,531,788, or U.S. 2010/0326343.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Other examples for energy converters are implemented as floating energy converters that extract energy from the motion of water in a wave passing the energy converter. The term “wave energy converter” as used herein refers to a device that floats on the surface of a body of water while extracting energy (via lift, rotation, and/or tilt relative to the sea bed) from the circular motion of water particles passing the wave energy converter. Thus, submerged turbine devices based on the bulk flow of water are expressly excluded from the meaning of the term ‘wave energy converter’. To maximize energy harvest, wave energy converters can be deployed in relatively large arrays to aggregate their power production, which requires that each wave energy converter occupies an area under the influence of changes in wave, current, and wind direction within which no other WEC is permitted. Thus, it is readily apparent that arrays of wave energy harvesters will occupy substantial areas. As each single wave energy converter requires in most cases between one and four mooring structures (see e.g., U.S. 2014/0090365, EP 2713042, U.S. Pat. No. 8,686,582, or WO 2013/182837), currently known moorings in arrays are environmentally disruptive to the sea bed and present a substantial financial burden. Compounding such difficulties is the fact that each mooring anchor must be able to withstand the maximal forces to which a single wave energy converter can be subject under extreme conditions. Not surprisingly, the cost of such a complex set of moorings and connections rival the costs of the wave energy converters themselves.

Moreover, each WEC has a power line, whether electrical or fluid-transporting, which is typically hooked into a manifold on the sea bed. As a result of current design, wave energy converter farms must often cover a large area, require extensive cable lengths, and often need a significant number of mooring anchors. In addition, sea life and especially whales tend to become entangled or injured by the multitude of mooring lines in arrays of wave energy converters, which further raises ecological concerns. While tether structures are conceptually relatively simple and allow for flexibility for at least some of the submerged turbine systems as described above, tether structures are often deemed not suitable or even applicable to floating energy converters. For example, individual tether structures are thought to be easily tangled if not sufficiently spaced apart or prone to breaking due to tensional forces where multiple wave energy converters are attached to a single tether.

Therefore, while many mooring structures for marine energy converters are known in the art, all or almost all of them suffer from one or more disadvantages, particularly where multiple wave energy converters are to be deployed in an array. Consequently, there is still a need for improved systems and methods of mooring an array of wave energy converters.

### SUMMARY OF THE INVENTION

The present inventive subject matter is drawn to various systems, configurations, and methods of mooring wave energy converters in an array in which a plurality of wave energy converters are coupled to a primary tether via respective secondary tethers. Most preferably, the primary tether is coupled to the seabed via one or more anchors, and larger arrays can be manufactured from multiple primary tethers (which may or may not be coupled on one end to the same anchor at the seabed) each carrying multiple secondary tethers while the spacing of the secondary tethers is preferably such that at least two of the wave energy converters are not positioned at the same time at the wave maximum of a passing wave. Viewed from another perspective, the length of the secondary tethers (and in some cases also the length of the primary and secondary tethers) are chosen such that at least two, more typically at least half, and most typically all of the wave energy converters have a distance between successive converters as measured along an axis parallel to the motion of a passing wave that is shorter that the shortest wavelength that is typically encountered at the location of the array (while the wave travels in the predominant direction). It should be particularly noted that such arrangement advantageously reduces tension forces on the primary tether and anchor to which the primary tether is coupled, reduces the ratio of mooring lines per energy converter in an array and thus the potentially adverse impact on the environment, as well as reduces complexity and deployment of a wave energy converter array. Most typically, the spacing of the secondary tethers is chosen such that each floating wave energy converter has all degrees of freedom on the surface of the water without at least two (and most typically all) of the converters contacting each other or overlapping their respective secondary tethers.

Thus, especially preferred systems and methods afford for flexible mooring of a large number of wave energy converters using a significantly reduced number of mooring lines. Moreover, systems and methods contemplated herein also allow for simple and effective production of large arrays of wave energy converters that can be easily deployed and maintained in a cost effective as well as environmentally friendly manner.

In one aspect of the inventive subject matter, a mooring system for an array of wave energy converters comprises first and second sea bed anchors that are coupled to a primary tether. A plurality of secondary tethers, each having first and second ends, are coupled to the primary tether via respective first ends, and each of the second ends has a coupling mechanism that allows the secondary tether to retain a wave energy converter. The secondary tethers are coupled to the primary tether at predetermined distances along a length of the primary tether.

In some aspects of the inventive subject matter, the length of the primary and/or secondary tethers is chosen such that at least two of the wave energy converters have a distance of separation (as measured along the axis that is parallel to the motion of a passing wave) that is shorter than the shortest wavelength typically encountered at the location of the array (e.g., less than 50 m, less than 40 m, less than 30 m, less than 20 m, less than 10 m). Additionally, it is contemplated that the length of the primary and/or the secondary tethers is chosen such that the primary and/or secondary tethers are suspended off the seabed. While not limiting to the inventive subject matter, it is also contemplated that the primary tether has a fixed length while the secondary tether may be adjustable in length. Additionally, it is contemplated that the primary tether and the secondary tether have at least a ten to one length ratio.

Where desired, it is contemplated that the mooring system may further include a tertiary and optionally a quaternary tether coupled to the primary tether, wherein the tertiary and optionally quaternary tethers have a length that restricts side-to-side motion of the primary tether, and are preferably coupled to third and fourth seabed anchors located behind the first and second anchors for the primary tether (as seen in direction of the wave trave). In further aspects, at least a second primary tether may be coupled via at least one end to the first and/or second sea bed anchors, and the second primary tether may further comprise a second plurality of second secondary tethers. It should be noted that the length of the tertiary and/or quaternary tethers may be adjusted in response to a measured wave direction, wave amplitude, and/or current direction.

Therefore, and viewed from a different perspective, a mooring system for an array of wave energy converters is contemplated that includes a plurality of primary tethers to which a plurality of secondary tethers are coupled, respectively, wherein the secondary tethers are coupled to the respective primary tethers at predetermined distances along a length of the primary tether, and wherein at least two of the primary tethers are coupled to a shared seabed anchor.

In such mooring systems it is contemplated that the length of the primary and/or plurality of secondary tethers is chosen such that at least two the wave energy converters when coupled to the secondary tethers have a distance of separation (as measured along an axis parallel to the motion of a passing wave) that is shorter than the shortest wavelength that is typically encountered at the location of the array. Additionally, primary tethers may be coupled to respective tertiary tethers in contemplated mooring systems, and/or contemplated systems may further include at least three primary tethers that are coupled to the shared anchor. Most typically, the primary tethers and the secondary tethers have at least a five to one, or at least a ten to one length ratio.

In other aspects of the inventive subject matter, an array of wave energy converters is contemplated that includes a plurality of wave energy converters that are coupled to a common primary tether via respective plurality of secondary tethers, wherein the primary tether has a first end and a second end, and wherein the first and second ends of the primary tether are coupled to first and second seabed anchors, respectively.

As indicated before, it is contemplated that at least two, or at least three, or at least four wave energy converters may be coupled to a primary tether, and that a second primary tether may be coupled to the first and/or second seabed anchors.

Consequently, the inventors also contemplate a method of wave energy converter deployment that includes a step of coupling a first and a second wave energy converter to a primary tether through respective first and second secondary tethers. In another step, one end of the secondary tethers is coupled to the wave energy converter and another end of the secondary tether is coupled to the primary tether, wherein the secondary tethers are coupled to the primary tether at predetermined distances along a length of the primary tether.

Contemplated methods will also include a step of first coupling an anchor to the primary tether, and then coupling the secondary tether to the primary tether, and/or a step of first deploying an anchor, the primary tether, and the secondary tether coupled to the primary tether, and then coupling the wave energy converters to the secondary tethers. Alternatively, contemplated methods may comprise a step of supplying the secondary tether with a buoyant element.

In still further aspects of the inventive subject matter, a method of adjusting length of a secondary tether length is contemplated where the secondary tether secures a wave energy converter. In such methods, a location characteristic of a wave energy converter is detected, and then a calculated location is determined for a desired power generation factor. In another step, length of the secondary tether is increased or decreased to thereby achieve the desired power generation factor.

While not limiting to the inventive subject matter, a global positioning system may be used to determine the location characteristic of the wave energy converter, and/or the location characteristic may be determined relative to at least one other wave energy converter.

In yet another aspect of the inventive subject matter, a method of transferring power harvested by a wave energy converter to a main power line is contemplated that includes the steps of transforming ocean wave energy into potential or electrical energy through the use of the wave energy converter, and another step of transferring the potential or electrical energy from a generator line of the wave energy converter to a main power line through fluid, conductive, or inductive coupling, wherein the generator line is configured as or coupled to a secondary tether and wherein the main power line is configured as or coupled to a primary tether. Additional potential or electrical energy may be transferred from a second generator line of a second wave energy converter to the main power line.

Various objects, features, aspects and advantages of the present invention will become more apparent from the following detailed description of preferred embodiments of the invention along with the accompanying drawing.

### BRIEF DESCRIPTION OF THE DRAWING

FIG. 1 is an exemplary schematic illustrating a mooring system according to the inventive subject matter having two primary tethers and 11 wave energy converters coupled to the primary tethers via a plurality of secondary tethers at a wave direction of 0 degrees relative to predominant wave direction.

FIG. 2 is the exemplary mooring system of FIG. 1 at a wave direction of 45 degrees relative to predominant wave direction.

FIG. 3 is a sectional view of the exemplary mooring system of FIG. 1 having different lengths of the first and second primary tethers (upper panel A and lower panel B).

FIG. 4 is an exemplary schematic perspective view illustrating a mooring system according to the inventive subject matter as deployed with the primary and secondary tethers positioned off the seabed.

FIG. 5 is a simplified exemplary schematic illustrating a mooring system according to the inventive subject matter having one primary tether and a tertiary tether in a triangular configuration at two different wave directions.

FIG. 6 is a simplified exemplary schematic illustrating a mooring system according to the inventive subject matter having one primary tether and a tertiary tether in a triangular configuration at multiple wave directions.

FIG. 7 is a simplified exemplary schematic illustrating a mooring system according to the inventive subject matter having one primary tether and a tertiary tether in a rectangular configuration at two different wave directions.

FIG. 8 is an exemplary schematic illustrating multiple serially coupled mooring systems according to the inventive subject matter having multiple tertiary tethers.

### DETAILED DESCRIPTION

The inventors have discovered that wave energy converters and arrays of wave energy converters can be constructed and deployed in a conceptually simple and effective manner in which one or more wave energy converters are coupled to a primary tether via one or more respective secondary tethers. In further preferred aspects, the ends of the primary tethers are maintained on the seabed via one or more anchors, and tertiary (and higher) tethers may be employed to achieve a desired geometry/configuration of an array of wave energy converters. Using multiple primary tethers and respective multiple secondary tethers therefore allows formation or large arrays of wave energy converters with minimal impact on the seabed.

Thus, and viewed from a different perspective, a mooring web is contemplated that comprises one or more primary tethers extending substantially laterally between two or more seabed anchors from which a plurality of secondary tethers extend in substantially upwardly direction (relative to the seabed), which retain respective wave energy converters. Moreover, it is generally preferred that the primary and secondary tethers will have a length that allows the primary and/or secondary tethers to remain suspended off the seabed during operation of the wave energy converters. Therefore, contemplated systems and methods advantageously allow for anchoring multiple wave energy converters using a minimum of tethers and seabed anchors. For example, it should be appreciated that three, four, five, six, and even more independently movable wave energy converters may be retained in place while generating energy using only two seabed anchors and a single common primary tether.

It should also be appreciated that a mooring system as presented herein will be able to connect many wave energy converters to two (serial or parallel) primary tethers in a comb of tethers. Because the wave energy converters are located in a defined pattern relative to each other, it should be also appreciated that only a few wave energy converters at a time will contribute to the pulling stress on the primary tethers as further discussed in more detail below. Additionally, it should be noted that by overall reduction of the number of anchors and tethers, overall costs are considerably reduced. Further advantages can be realized by above-water connection of the wave energy converters to their secondary tethers, and by above-water connection of the secondary tethers to the primary tethers. Moreover, most of the electrical or pipe connections can be made above water, leaving only a few connections (e.g., two connections at either end of the mooring system) to be made on the seabed. In still further advantageous aspects, and especially where multiple mooring webs are chained one after another across prevailing wave fronts, successive webs can share the same anchors, tethers, and/or energy transmission lines as also further discussed below.

Consequently, it should be recognized that in one aspect of the inventive subject matter a mooring system for wave energy conversion may include a first and a second anchor that are coupled to a primary tether, and a secondary tether that is coupled to the primary tether and configured to allow coupling of a wave energy converter. Most typically, the secondary tether is configured such as to allow for independent movement of the wave energy converter that is coupled to the secondary tether, and to also allow to freely adjust the position of the wave energy converter to wavelength and amplitude variations. While all permutations are deemed suitable for use herein, it is typically preferred that the primary tether has a fixed length and that the secondary tether is adjustable in length. To maintain the array in place, it is generally contemplated that the primary tether is removably or fixedly coupled to an anchor that is positioned or located on the sea bed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. Moreover, the recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Furthermore, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

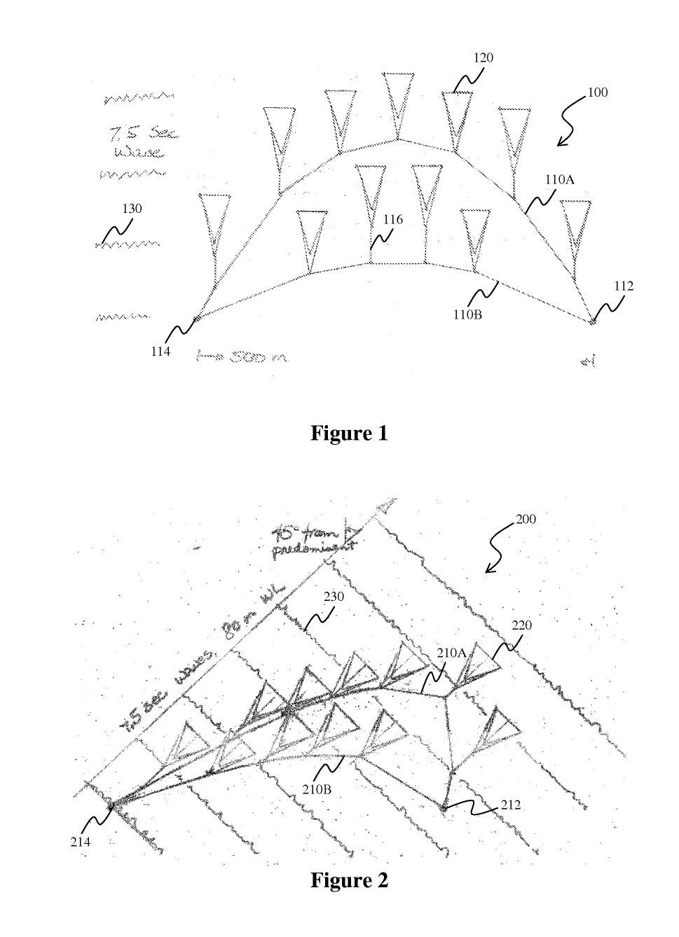

FIG. 1 exemplarily and schematically illustrates a mooring web 100 with an array of wave energy converters 120 in which each of the converters 120 is coupled to one end of a secondary tether 116 (which may be configured as a single tether, a bifurcated tether, or a set of tethers) while the other end of the secondary tether is coupled to the primary tether 110. In the example of FIG. 1, there are two distinct primary tethers 110A and 110B, which are coupled at their respective ends to seabed anchors 112 and 114. It should be noted that in the depiction of FIG. 1 the wave energy converters 120 are floating on the surface of the water while converting energy and that the orientation of the wave energy converters is driven by the wave direction of waves 130. Most typically, the seabed anchors and primary tethers are oriented such that a hypothetical line between the anchors substantially perpendicularly (i.e., +/−20 degree) intersects hypothetical line following the predominant wave direction. The term “predominant wave direction” refers to the direction in which waves move the majority (i.e., at least 50%, or at the peak of a graph illustrating the distribution of angles) of time at a given location. While FIG. 1 provides exemplary measures, it should be noted that the dimensions may vary considerably without departing from the inventive concept presented herein.

It should, be appreciated that due to the flexibility of the primary and secondary tethers, and the fact that the secondary tethers can move independently relative to each other and move pivotably relative to the primary tethers, the mooring web can distort as the wave direction changes, but will sustain operability for the wave energy converters and will also maintain a minimum or predetermined distance (e.g., distance that avoids collision or entanglement) between neighboring wave energy converters as can be taken from FIG. 2. Here, the wave direction of waves 230 has changed to 45 degrees from the predominant wave direction as compared to zero degrees in FIG. 1. Nevertheless, the web 200 is operable with primary tethers 210A and 210B distorted in the direction of the waves. It should be noted that the seabed anchors 212 and 214 remain stationary in this configuration. Distortion of the web is typically due to at least two factors, typically drag forces in the wave motion and wind and/or current forces acting on the floating wave energy converters 220.

It should be particularly recognized that because of the use and arrangement of the primary and secondary tethers in such arrays substantial advantages can be achieved. For example, it is pointed out that although less wave energy flows between the two fixed seabed anchors upon change of wave direction, the total energy captured remains relatively close to the optimum, being roughly the sine of the angle of the wave fronts relative to the prevailing direction. For most locations waves rarely have a deviation of more than 45 degree off the prevailing direction, and the sine of 45 degrees is 71%, efficient energy harvest can be achieved over a relatively large degree of wave directions without active adjustment of the wave energy converters in the array, or without active adjustment of the entire array.

Most typically, it is preferred that the length of the primary/or secondary tethers is chosen such that at least two (or at least three, or at least four, or at least five or more, or all) of the wave energy converters have a distance, as measured along an axis parallel to the motion of a passing wave, that is shorter than the shortest wavelength that is typically encountered at a location of the array. Viewed from another perspective, the spacing of the wave energy converters in the predominant direction of the wave may be even by pairs, and that the distance in the predominant direction of the wave is in increments for each successive pair, no matter which their primary is. For example, in FIG. 1, the outer two wave energy converters on the inside primary tether 110B are hit are first by the wave crest, followed by the outer wave energy converters on the outer primary tether 110A, followed by the inner wave energy converters on the inner primary tether 110B, followed by the successive pairs or individual wave energy converters on the outer primary tether 110A. Thus, a staggered arrangement relative to the wave direction is particularly preferred in which successive wave energy converters (on one or more primary tether) are hit by a wave crest at successive times. Most typically, the wave energy converters are staggered in increments that are less than the shortest wavelength (in predominant wave direction) typically encountered, so that for longer waves, which are more powerful, the wave crest encounters a reduced number of wave energy converters (e.g., only one pair of wave energy converters in FIG. 1) at a time. This advantageously reduces the forces on the tethers and anchors and evens it out, and the flexibility of the primary tethers, which are typically pulled through the water at the point of connection, further reduces the force transmitted to the anchors.

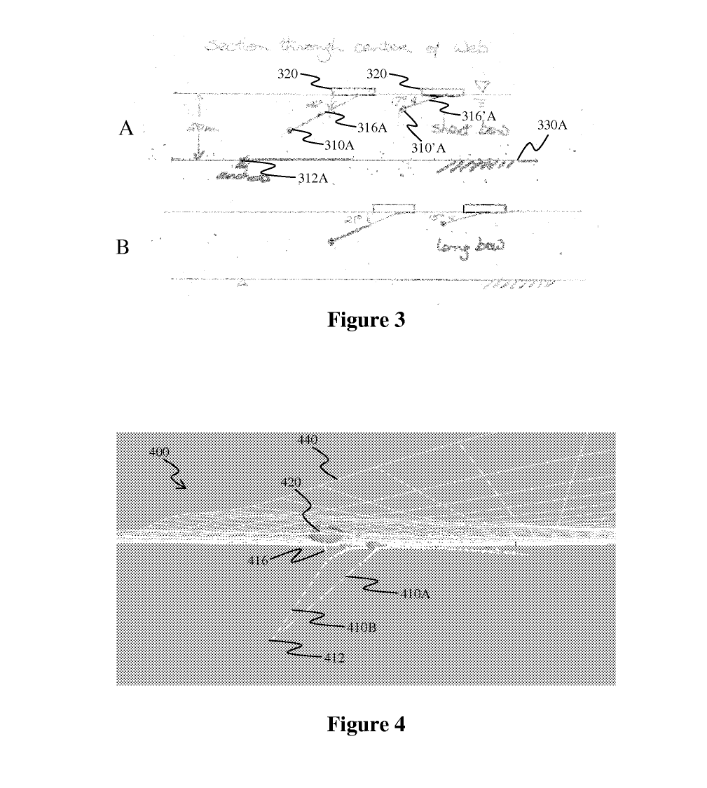

As should also readily appreciated, the wave energy converters are under tension from the mooring web. The vertical and horizontal components of this tension can be adjusted by the length of the main mooring line. In the elevation view of FIG. 3 seen through the center of the mooring web, shorter (upper panel A) and longer (lower panel B) primary tethers are shown, each as a dot at the left end of each secondary tether. The optimum angle of the secondary tether to the wave energy converter can be determined for each type of device using methods well known in the art. In panel A, seabed anchor 312A (located on seabed 330A) holds one end of the first primary tether 310A (shown as a dot) and of the second primary tether 310′A. Respective secondary tethers 316A and 316′A are coupled to the individual wave energy converters 320 that float on the surface of the body of water. As can be seen from the corresponding panel B, extension of the primary and/or secondary tethers will result in a smaller angle as indicated in FIG. 3. FIG. 4 schematically illustrates a perspective view of a mooring web 400 having first and second primary tethers 410A and 410B, to which secondary tethers 416 are coupled, and which in turn retain wave energy converters 420 that float on the water surface 440 while converting energy.

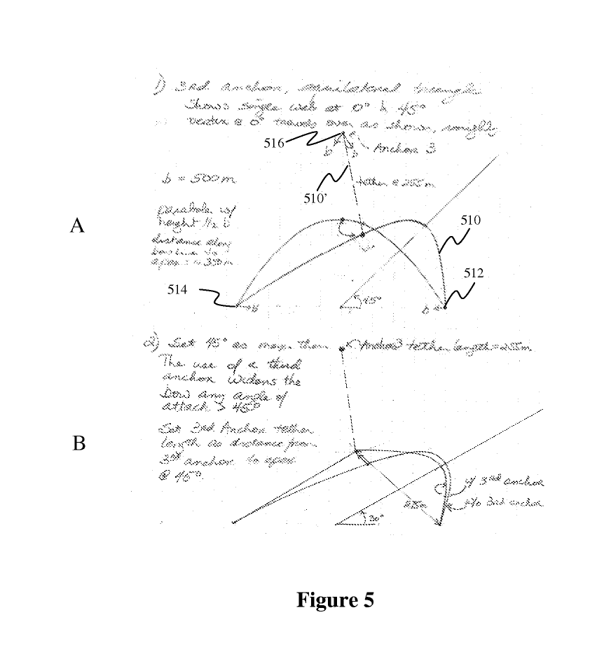

Additionally, a tertiary tether (or even quaternary tether) may be added to prevent the mooring web from collapsing as shown in FIG. 5 in which a single tertiary tether is placed at the apex of an equilateral triangle and which is an exemplary configuration only. It should be appreciated that other, non-equilateral triangular arrangements are also suitable. Here, and as shown in the upper panel A, anchors 512 and 514 retain primary tether 510 (secondary tethers and wave energy converters omitted for simplicity). Third anchor 516 is positioned at the tip of the equilateral triangle formed by the anchors, and a tertiary tether 510′ is coupled to the middle or near the middle (+/−20% off the center) of the primary tether 510. As can be readily seen from the upper panel A, when the wave direction is 45 degrees off the predominant wave direction, the tertiary tether dampens excursion of the primary tether 510, and when the wave direction is 60 degrees off the predominant wave direction, the tertiary tether opens up the usable primary tether space by virtue of its fixed length as shown in the lower panel B.

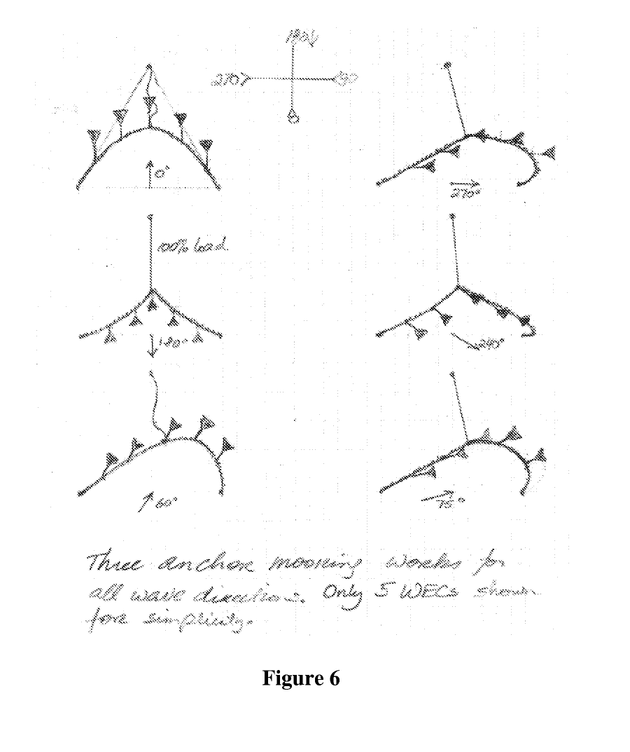

Thus, it should be appreciated that a tertiary tether may be employed to maintain or even increase efficiency where the deviation of the wave direction is beyond a predetermined level. FIG. 6 exemplarily shows the possible deformed configurations of a primary tether at selected wave directions where a tertiary tether is coupled to a primary tether in an equilateral triangular configuration. Thus, where desirable, a tertiary tether (and optionally a quaternary tether) may be coupled to the primary tether such as to maintain a predetermined shape or range of configurations of the primary tether. Such tertiary and/or quaternary tethers may be adjusted in dependence of the wave direction, wave amplitude, and/or current. Furthermore, it should be noted that these tethers are preferably held in place via supplemental anchor(s).

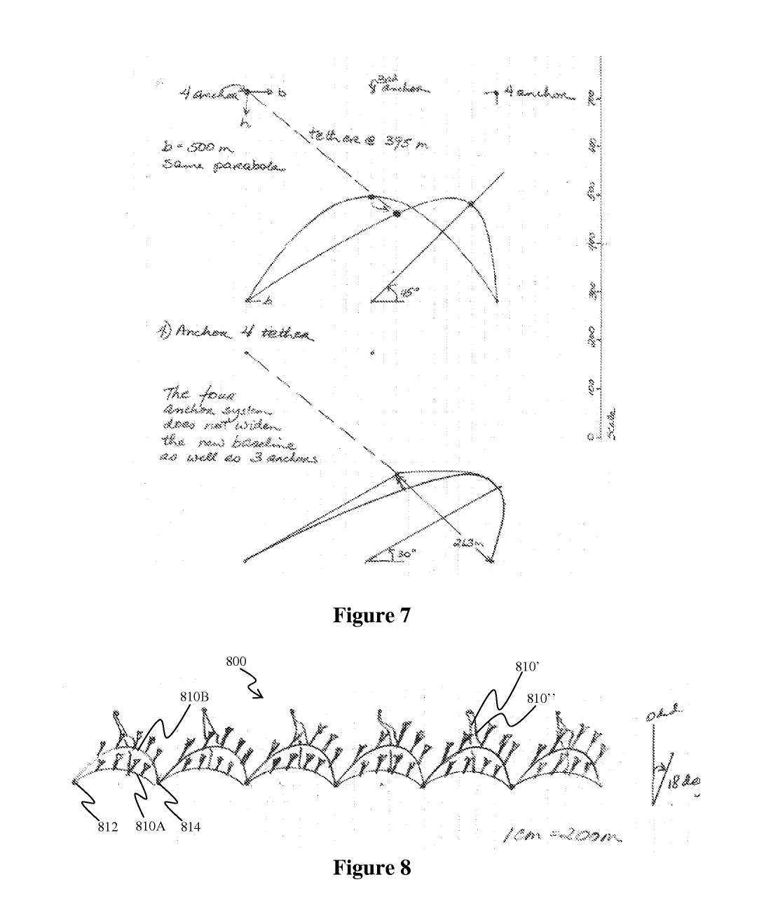

Alternatively, tertiary and/or quaternary tethers may also be employed as exemplarily depicted in FIG. 7. Here the seabed anchors are placed in a rectangular configuration and the same considerations as provided for FIG. 5 apply to FIG. 7. Notably, use of a tertiary and/or quaternary tether in a rectangular or trapezoidal configuration may not provide as substantial advantages in a simple model upon wave direction deviation from the predominant wave direction as compared to a triangular arrangement. However, use of a tertiary and/or quaternary tether in a rectangular or trapezoidal configuration may be particularly beneficial for flatter webs. Moreover, it should be noted that the anchor for tertiary and/or quaternary tethers may be placed based on considerations other than geometry. For example, an anchor and tertiary tether may be placed in response to a second or alternate prevailing wave direction.

In further contemplated aspects of the inventive mooring systems, additional (second, third, etc.) primary and/or secondary tethers may be employed to generate a wave energy converter array. While not limiting to the inventive subject matter (and dependent on the dimensions of the array and depth of the sea bed), it is generally contemplated that the primary tether and the secondary tether have a length ratio of at least two to one, more typically at least five to one, and most typically at least ten to one. Therefore, it should also be recognized that an important advantages of contemplated systems and methods is the secondary tethers are short relative to the primary tethers, which reduces the watch circle and so allows for a higher density of wave energy converters (other other devices).

Thus, and viewed from a different perspective, a mooring system for wave energy conversion will include a plurality of primary tethers (e.g., at least two, at least three, etc.) to which a plurality of respective secondary tethers are coupled, and wherein at least two of the primary tethers are coupled to a shared anchor which may be a fixed anchor (e.g., suction pile, gravity anchor) or may be a movable/submersible anchor. An exemplary configuration of multiple primary tethers coupled in series and in parallel is shown in FIG. 8. Here, array 800 has a plurality of anchors 812, 814 that retain two primary tethers 810A and 810B. As can be seen, anchor 814 is a common anchor for four primary tethers and is arranged in series with further set of anchors. Tertiary tethers 810′ and 810″ are coupled to the primary tethers 810A and 810B. In the example of FIG. 8, the tertiary tethers are not under tension as the wave direction has only a moderate deviation (here: 18 degrees). As noted before, it is generally preferred that the primary tether is configured to have a fixed length. While not limiting to the inventive subject matter, it is generally preferred that the primary tethers and the secondary tethers have a length ratio of at least five to one, and more typically at least ten to one.

Consequently, the inventors also contemplate an array of wave energy converters that includes a plurality of wave energy converters that are coupled to a common primary tether via respective plurality of secondary tethers. In preferred arrays, at least five wave energy converters are coupled to a primary tether, and/or the primary tether is coupled to the sea floor via an anchor (e.g., at a depth of at least 5 meter, more typically at least 10 meter, and most typically at least 20 meter below the sea surface).

Of course, it should be appreciated that the depth of the anchors may vary due to tidal and/or wave action, and that the length of the primary and/or secondary tethers may be adjusted to accommodate a particular configuration to improve or enable energy conversion. Adjustment of length could be achieved actively, for example, in motorized or otherwise actuated manner, or passively using elastic tethers and/or a combination of alternating flotation and clump weights on the secondary tether, thereby creating kinks in the line that flatten under tension. Such elastic or adjustable tethers will allow carrying back of the wave energy converters by the crests of the waves and then resuming to their original position in the wave trough. Notably, such elastic or adjustable tethers are also thought to reduce loads, and extend the time they are being activated.

Therefore, the inventors also contemplate a method of adjusting the primary and/or secondary tether length in which in one step a location characteristic (e.g., absolute position relative to sea bed, anchor, and/or primary tether, etc.) of a wave energy converter is detected. A calculated location for a desired power generation factor is then determined, and first and/or second secondary tether lengths are then adjusted to thereby achieve the desired power generation factor. As may be readily appreciated, a global positioning system can be used to determine the location characteristic of the wave energy converter. Alternatively, or additionally, the location characteristics may also be determined relative to at least one other wave energy converter, for example, by distance measurement using optical and/or electromagnetic signals.

Due to the relatively simple configuration of contemplated arrays, it should also be recognized that a method of wave energy converter deployment is significantly simplified. For example, and in general, contemplated methods will require a step of coupling a wave energy converter to a primary tether through a secondary tether. Such methods can be performed in a variety of manners. For example, an anchor may be first coupled to the primary tether, and the secondary tether is then coupled to the primary tether. Alternatively, the anchor(s), the primary tether(s), and the secondary tether(s) coupled to the primary tether(s) may be deployed in a first step, while coupling of the wave energy converter(s) to the secondary tether(s) is performed in a second step. To assist in deployment, each of the components may be buoyed prior to coupling. For example, the secondary tether may be deployed with a buoyant element to so maintain one end of the secondary tether at or near the surface. In yet another method of deployment, the inventors contemplate that the anchors are deployed with the lowest section of primary tether only, buoyed to the surface. Then the central piece of primary tether with the secondary tethers already attached is connected at each end to the lower sections; these are long enough to reach the surface. Among other benefits, it should be noted that in such solution one can use chain for the lower sections, which is cheap and permanent, while the typical fiber hawsers used in tension mooring may need periodic replacement. The hawsers are neutrally buoyant, so they work for the middle of the web, and they are cheaper than putting flotation on chain.

Moreover, it should be appreciated that the sequence of construction can be optimized to reduce time at sea. For example, anchors can be pulled in or placed (suction pile or gravity) with a primary tether already attached and buoyed to the surface. Next, the power lines to shore can be laid along the row of anchors or tethers, with vertical branches at each tether buoyed off to the surfaces as well. The vertical branches of these power lines or pipes accompany the primary tethers and can be linked loosely using hoops. Then the remaining primary tether and attached power line is installed. This portion of primary tether can be prefabricated with secondary tethers and branching of power lines already attached; the secondary tethers are now buoyed. As a final step, the wave energy converters are towed to the site and attached, again above water, to the secondary tethers or their prepared spot on the primary tethers when there are no secondary tethers. All branching of power lines or pipes can be done on-shore during prefabrication, leaving a single in-line connection for each wave energy converter. Attaching the wave energy converters can be done at the surface with smaller work boats.

Thus, mooring webs contemplated herein can reduce the number of anchors and tethers to a small fraction of the number of wave energy converters, while the holding force of these anchors and tethers is a small multiple of that required for a single wave energy converter. The density of wave energy converters is increased, and the moorings will be under tension almost all the time, which makes them whale-friendly, and switching out wave energy converters for maintenance is simplified. Lastly, it should be appreciated that any floating wave energy converter system which is directionally moored can benefit from the configurations and methods presented herein.

With respect to power transfer it is generally contemplated that power harvested by a wave energy converter can be transferred to a main power line, and typically then to an end device for ultimate distribution to a substation or grid. Most commonly, the harvested power is transmitted via hydraulic lines to a common line (under water or on shore) and then transformed into electrical energy via generator. Alternatively, the WEC may generate electrical energy directly or indirectly that is then transferred to a main line. Thus, kinetic energy or electric energy can be transferred from a generator line of the wave energy converter to a main power line through a variety of manners, including hydraulic lines, pneumatic lines, electrically conductive lines, etc. Depending on the manner of transmission, coupling of the individual portions in the transmission chain may be via fluid coupling, electric coupling, inductive coupling, etc.

Where tertiary and/or quaternary tethers are used, it should be noted that these may also be employed as carriers of transmission lines or act as transmission lines. Thus, it is also contemplated that the generator line may be configured as or coupled to a secondary tether and/or that the main power line is configured as or coupled to the primary tether. For example, it is contemplated that where the kinetic wave energy is transferred via a hydraulic fluid, a flexible reinforced polymer hydraulic pipe will typically have sufficient tensile strength to act as a secondary tether, so that the pipe is or forms part of the secondary tether, which is then flexibly attached (and preferably fluidly coupled) to the primary tether, and subsequently to the main power line/pipe. In the case of a tertiary tether, the attraction of having the main power line/pipe descend to shore from the primary tether is two-fold: the main does not have to be as long, as it ends at the secondary tethers of the outermost wave energy converters and also it does not have to carry more than half the power generated on a primary, so it can be smaller than a main that accumulates all the power generated on a single primary. The two main power lines/pipes meet in the center of the primary and the energy goes down the tertiary tether which is larger in capacity, to a mainline to shore.

With respect to suitable wave energy converters it should be noted that all known floating wave energy converters are deemed suitable for use herein, and especially preferred wave energy converters include those that convert wave energy from change in height above the seabed, change in relative position of movable portions, and pitch, roll, and/or yaw of the wave energy converter. Moreover, it should be appreciated that contemplated mooring systems are also beneficial for sea-based devices other than wave energy converters. Indeed, it should be appreciated that all configurations, systems, and devices are deemed appropriate where multiple units are tethered in the sea, including pleasure craft, floating wind generators, aquaculture cages (for fish), and lattices for shellfish.

Likewise, it should be noted that the tethers can be manufactured from numerous materials, and especially suitable tether materials include various metals and metal alloys, and natural and/or synthetic polymers. Such tether materials may be configured as solid or hollow tubes, braided, woven, or otherwise intertwined as cables, ropes, etc. Consequently, the tethers may be rigid (i.e., extend in length under average operating conditions no more than 5%), somewhat elastic (i.e., extend in length under average operating conditions between 5.1 and 15%), or elastic (i.e., extend in length under average operating conditions at least 15.1%), and the person of ordinary skill in the art will readily be appraised of a suitable choice for a particular mooring configuration. Most typically, the tensile strength of the primary tether will be larger than the tensile strength of the secondary tethers, but generally be less than the sum of the combined tensile strengths of the secondary tethers. Moreover, and as already noted above, the primary tethers will generally have a substantially greater length than the secondary tethers, and suitable ratios of primary to secondary tether lengths are between 2:1 and 5:1, between 5:1 and 10:1, between 10:1 and 20:1, between 20:1 and 50:1, and even larger than 50:1. It should further be noted that while it is preferred that the length of the primary and/or secondary tethers is fixed, the length may also be actively (e.g., using a retraction mechanism that is preferably automated) or passively (e.g., using elastic portions) adjusted. While it is generally preferred that the primary and/or secondary tethers are single lines, it should be recognized that the primary and/or secondary tether may be configured as a split tether, a forked tether, or even as multiple tethers.

Primary and secondary tethers are preferably non-permanently coupled together using a reversible coupling mechanism, and especially contemplated coupling mechanisms include various physical mechanisms (e.g., quick-connect couplings, hooks, shackles, locks, knots, etc.), chemical mechanisms (e.g., reversible bonding agents), and even (electro)magnetic coupling. Likewise, the primary and secondary tethers may also be permanently coupled, and suitable permanent couplings include splicing, gluing, or welding. Similarly, the wave energy converters will preferably be coupled to the secondary tether in a removable fashion, typically using the same type of coupling mechanism as described above. Thus, it should be noted that the primary tether may be coupled to the anchor in a removable manner using the coupling mechanism as described above, as well as that the secondary tethers may be coupled to the primary tether and/or the wave energy converter using the type of coupling mechanisms described above.

With respect to the seabed anchors it is generally contemplated that any seabed anchor may be suitable, including those of the foundation type, dragged-in, drilled-in, suction pile, caisson type foundation, gravity, etc. to retain the anchor in a fixed position relative to the seabed. However, it should be noted that movable anchors (laterally via rails, chains, etc., and/or vertically via adjustment of buoyancy) are also deemed suitable for use herein. Where multiple anchors and multiple primary tethers are used, it is further contemplated that the anchors are arranged in a geometric manner. For example, it is contemplated that multiple anchors are arranged in series in a relatively straight line that perpendicularly intersects the predominant wave direction. On the other hand, anchors could also be arranged in a circular or polygonal manner, or may curve to follow the depth along a coastline.

Still further, it is noted that at least some of the anchors may also be replaced by a coupling mechanism that is attached to a rock or otherwise fixed subsea structure, or that at least some of the anchors may be replaced by a coupling mechanism that is attached to an on-shore fixed structure.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A mooring system for an array of wave energy converters comprising:
a first and a second sea bed anchor coupled to a primary tether;
a plurality of secondary tethers having respective first and second ends, wherein each of the first ends is coupled to the primary tether, wherein each of the second ends has a coupling mechanism to retain a wave energy converter; and
wherein the secondary tethers are coupled to the primary tether at predetermined distances along a length of the primary tether.

2. The mooring system of claim 1 wherein the length of at least one of the primary and the plurality of secondary tethers is chosen such that at least two of the wave energy converters have a distance, as measured along an axis parallel to the motion of a passing wave, that is shorter than a shortest wavelength that is typically encountered at a location of the array.

3. The mooring system of claim 1 wherein the length of the primary and the plurality of secondary tethers is chosen such that the primary and the plurality of secondary tethers are suspended off the seabed.

4. The mooring system of claim 1 wherein the primary tether has a fixed length and the secondary tether is adjustable in length.

5. The mooring system of claim 1 wherein the primary tether and the secondary tether are configured to have at least a ten to one length ratio, respectively.

6. The mooring system of claim 1 further comprising a tertiary and optionally a quaternary tether coupled to the primary tether, wherein the tertiary and optionally quaternary tether has a length that restricts side-to-side motion of the primary tether.

7. The mooring system of claim 1 further comprising at least a second primary tether coupled via at least one end to at least one of the first and second sea bed anchors.

8. The mooring system of claim 7 wherein the second primary tether further comprises a second plurality of second secondary tethers.

9. The mooring system of claim 2 wherein the length of the primary and the plurality of secondary tethers is chosen such that the primary and the plurality of secondary tethers are suspended off the seabed.

10. The mooring system of any one of claims 2-3 wherein the primary tether has a fixed length and the secondary tether is adjustable in length.

11. The mooring system of any one of claims 2-4 wherein the primary tether and the secondary tether are configured to have at least a ten to one length ratio, respectively.

12. The mooring system of any one of claims 2-5 further comprising a tertiary and optionally a quaternary tether coupled to the primary tether, wherein the tertiary and optionally quaternary tether has a length that restricts side-to-side motion of the primary tether.

13. The mooring system of any one of claims 2-6 further comprising at least a second primary tether coupled via at least one end to at least one of the first and second sea bed anchors.

14. A mooring system for an array of wave energy converters, comprising:
a plurality of primary tethers to which a plurality of secondary tethers are coupled, respectively;
wherein the secondary tethers are coupled to the respective primary tethers at predetermined distances along a length of the primary tether; and
wherein at least two of the primary tethers are coupled to a shared seabed anchor.

15. The mooring system of claim 14 wherein the length of at least one of the primary and the plurality of secondary tethers is chosen such that at least two the wave energy converters when coupled to the secondary tethers have a distance, as measured along an axis parallel to the motion of a passing wave, that is shorter than a shortest wavelength that is typically encountered at a location of the array.

16. The mooring system of claim 14 wherein the at least two primary tethers are coupled to respective tertiary tethers.

17. The mooring system of claim 14 wherein at least three primary tethers are coupled to the shared anchor.

18. The mooring system of claim 14 wherein the primary tethers and the secondary tethers are configured to have at least a ten to one length ratio.

19. The mooring system of claim 15 wherein the at least two primary tethers are coupled to respective tertiary tethers.

20. The mooring system of any one of claims 15-16 wherein at least three primary tethers are coupled to the shared anchor.

21. The mooring system of any one of claims 15-17 wherein the primary tethers and the secondary tethers are configured to have at least a ten to one length ratio.

22. An array of wave energy converters, comprising:
a plurality of wave energy converters coupled to a common primary tether via respective plurality of secondary tethers, wherein the primary tether has a first end and a second end; and
wherein the first and second ends of the primary tether are coupled to first and second seabed anchors, respectively.

23. The array of wave energy converters of claim 22 wherein at least three wave energy converters are coupled to a primary tether.

24. The array of wave energy converters of claim 22 or claim 23 further comprising a second primary tether that is coupled to at least one of the first and second seabed anchors.

25. A method of wave energy converter deployment, comprising:
coupling a first and a second wave energy converter to a primary tether through respective first and second secondary tethers;
wherein one end of the secondary tethers is coupled to the wave energy converter and wherein another end of the secondary tether is coupled to the primary tether; and
wherein the secondary tethers are coupled to the primary tether at predetermined distances along a length of the primary tether.

26. The method of wave energy converter deployment of claim 25 further comprising a step of first coupling an anchor to the primary tether, and then coupling the secondary tether to the primary tether.

27. The method of wave energy converter deployment of claim 25 further comprising a step of first deploying an anchor, the primary tether, and the secondary tether coupled to the primary tether, and then coupling the wave energy converters to the secondary tethers.

28. The method of wave energy converter deployment of claim 25 further comprising a step of supplying the secondary tether with a buoyant element.

29. A method of adjusting length of a secondary tether length that secures a wave energy converter, comprising:
detecting a location characteristic of a wave energy converter;
determining a calculated location for a desired power generation factor; and
increasing or decreasing length of the secondary tether length to thereby achieve the desired power generation factor.

30. The method of claim 29 wherein a global positioning system is used to determine the location characteristic of the wave energy converter.

31. The method of claim 29 wherein the location characteristic is determined relative to at least one other wave energy converter.

32. A method of transferring power harvested by a wave energy converter to a main power line, comprising:
transforming ocean wave energy into potential or electrical energy through the use of the wave energy converter; and
transferring the potential or electrical energy from a generator line of the wave energy converter to a main power line through fluid, conductive, or inductive coupling;
wherein the generator line is configured as or coupled to a secondary tether and wherein the main power line is configured as or coupled to a primary tether.

33. The method of claim 32 further comprising transferring additional potential or electrical energy from a second generator line of a second wave energy converter to the main power line.
